(19) United States
(12) Patent Application Publication
(10) Pub. No.: US 2025/0315368 A1
(43) Pub. Date: Oct. 9, 2025

(54) APPLICATION PROGRAM QUALITY VERIFICATION SYSTEM, APPLICATION PROGRAM DISTRIBUTION DEVICE, AND STORAGE MEDIUM

(71) Applicant: DENSO CORPORATION, Kariya-city (JP)

(72) Inventors: Shinya ABE, Kariya-city (JP); Satoshi HORIHATA, Kariya-city (JP)

(21) Appl. No.: 19/241,021

(22) Filed: Jun. 17, 2025

Related U.S. Application Data
(63) Continuation of application No. PCT/JP2023/041811, filed on Nov. 21, 2023.

(30) Foreign Application Priority Data
Dec. 19, 2022 (JP) 2022-202157

(51) Int. Cl. G06F 11/3668

(52) U.S. Cl. CPC G06F 11/3688

(57) ABSTRACT

An application program quality verification system verifies the quality of the application program delivered to an on-board device from the application program distribution device. The system includes: a comparison unit that compares operational signals of the application program with comparison targets, a normal operation determination unit that determines whether the application program can operate normally based on the comparison results of the comparison unit, a practical use determination unit that determines whether the application program can be practically used based on the determination results of the normal operation determination unit, and a practical use control unit that allows the application program to be practically used when the practical use determination unit determines that the application program can be practically used.

### CROSS-REFERENCE TO RELATED APPLICATIONS

The present application is a continuation application of International Application No. PCT/JP2023/041811 filed on Nov. 21, 2023, which claims priority to Japanese Application No. 2022-202157, filed on Dec. 19, 2022. The contents of these applications are incorporated herein by reference in their entirety.

### BACKGROUND

### 1. Technical Field

The present disclosure relates to an application program quality verification system, an application program distribution device, and a storage medium.

### 2. Related Art

In recent years, application programs are implemented in vehicles. The purpose of application programs may be to ensure safe driving of vehicles. There are various application programs that may contribute to advanced driver-assistance systems (ADAS: Advanced Driver-Assistance Systems), for example. Conventionally, when an application program is updated to improve its functions or to fix bugs, the quality of the application program is verified in a simulation environment or by conducting test runs with a test vehicle. When a simulation environment is used to verify the quality of an application program, the conditions of the real world and the simulation environment may not match, and it takes time and money to make the conditions match. Collecting the necessary data for the simulation environment also requires time and cost. When conducting a test run with a test vehicle to verify the quality of an application program, time and cost are required to prepare a test vehicle and conduct the test run.

JP2021073547A1 discloses a system in which, a server acquires difference information indicating differences between actual land features and land features corresponding to the land feature information from a plurality of on-board devices provided with sensors that measure land features, send request of raw data, which is measured data of land features, to on-board devices, based on a confidence level calculated from the plurality of difference information, and acquires the raw data of a geographic feature that may have been changed from the on-board devices, and analyzes it in detail to identify changes in the geographic feature.

### SUMMARY

The system described in JP2021073547A1 identifies changes in geographical objects but cannot verify the quality of the application program. Therefore, it cannot solve the time-consuming and costly problem of verifying the quality of the application program.

This disclosure aims to provide an application program quality verification system, an application program distribution device, and a storage medium that can reduce time and cost required to verify the quality of application programs, properly verify the quality of application programs, and properly provide application programs whose quality is assured.

According to one aspect of this disclosure, in the application program quality verification system, a comparison unit compares operational signals of the application program with comparison targets. A normal operation determination unit determines whether the application program can operate normally based on the comparison results of the comparison unit. A practical use determination unit determines whether the application program can be practically used based on the determination results of the normal operation determination unit. A practical use control unit allows the application program to be practically used when the practical use determination unit determines the application program can be practically used.

In the present disclosure, the operational signals of the application program are compared with comparison targets, it is determined whether the application program can operate normally based on the comparison results of the comparison unit, it is determined whether the application program can be practically used based on the determination results of the normal operation determination unit, and the application program is allowed to be practically used when the practical use determination unit determined the application program can be practically used. According to this configuration, it is possible to reduce the time and cost required to verify the quality of the application program, appropriately verify the quality of the application program, and provide an application program whose quality is verified.

### BRIEF DESCRIPTION OF THE DRAWING

The above and other objects, features and advantages of the present disclosure will become clearer with the following detailed description with reference to the accompanying drawings. The drawings are,

FIG. 1 is a functional block diagram showing overall structure of the application program quality verification system according to a first embodiment;

FIG. 2 shows a shadow mode and a practical use mode;

FIG. 3 is a flowchart showing an application program registration determination process;

FIG. 4 is a flowchart showing a normal operation determination process;

FIG. 5 is a flowchart showing a practical use determination process;

FIG. 6 is a flowchart showing a shadow mode cancellation determination process;

FIG. 7 is a flowchart showing a normal operation determination process according to a second embodiment;

FIG. 8 is a flowchart showing a practical use determination process; FIG. 9 shows shadow and practical use modes according to a third embodiment;

FIG. 10 shows a shadow mode, a practical use mode, and a practical use mode suppression according to a fourth embodiment.

### DETAILED DESCRIPTION OF THE PREFERRED EMBODIMENTS

Multiple embodiments will be described below with reference to drawings. The description will be omitted for those portions of the subsequent embodiments that overlap with the preceding embodiments.

### First Embodiment

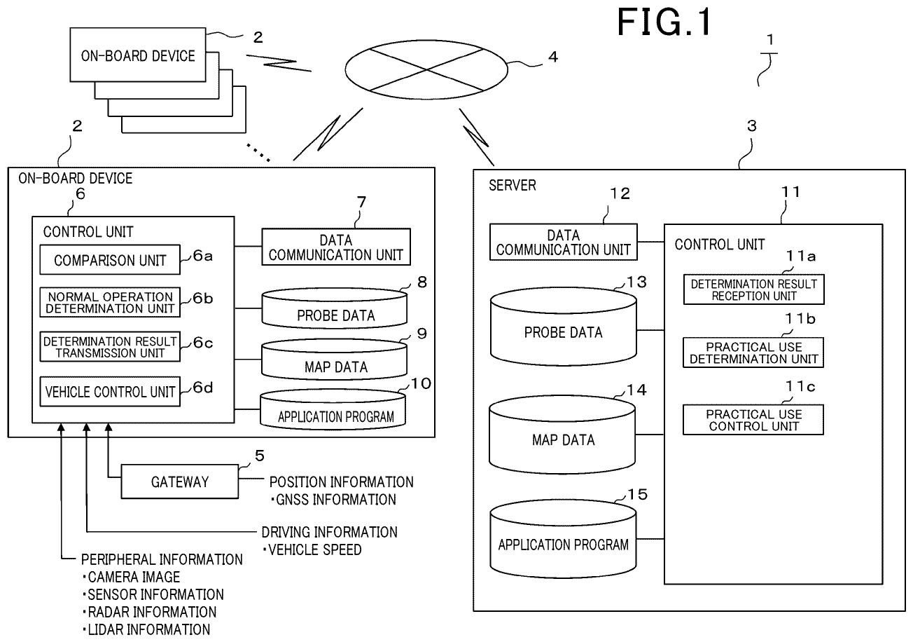

A first embodiment is described below with reference to FIGS. 1 to 6. As shown in FIG. 1, the application program quality verification system 1 includes an on-board device 2 mounted to a vehicle and a server 3 (which is an example of an application program distribution device). The on-board device 2 and the server 3 may communicate data via a communication network 4 including, for example, the Internet. The vehicle to which the on-board device 2 is mounted may be a vehicle with an automatic driving function or a vehicle without an automatic driving function. A vehicle with the automatic driving functionality switches sequentially between an automatic driving and a manual driving. A plurality of on-board devices 2 and the server 3 may communicate data.

The on-board device 2 inputs information of the vehicle's peripheral information, driving information, and position information from various sensors and various electronic control units (ECU) mounted to the vehicle. The peripheral information includes, for example, camera images ahead of the vehicle imaged by an onboard camera, sensor information of the vehicle's peripheral detected by radar sensors, and lidar (Light Detection and Ranging, Laser Imaging Detection and Ranging) information of the vehicle's peripheral detected by lidar. The on-board camera, sensors, radar, and lidar are autonomous system sensors, and the surrounding information is information acquired by autonomous system sensors. The camera image may include traffic signals, signs, billboards, road surface markings, stop lines at intersections, crosswalks, diamond-shaped markings at intersections, etc. The on-board device 2 acquires at least one of the camera images, the sensor information, the radar information, and the lidar information as the vehicle's peripheral information.

The driving information may be, for example, vehicle speed information detected by the vehicle sensors. The position information may be, for example, GNSS information located by a GNSS (Global Navigation Satellite System) receiver. GNSS is a generic term for pan-terrestrial navigation satellite systems, including GPS (Global Positioning System), GLONASS (Global Navigation Satellite System), Galileo, BeiDou, IRNSS (Indian Regional Navigational Satellite System), and others.

The on-board device 2 includes a control unit 6, a data communication unit 7, a probe data memory unit 8, a map data memory unit 9, and an application program memory unit 10. The control unit 6 is composed of a microcomputer (processor) with a CPU (Central Processing Unit), ROM (Read Only Memory), RAM (Random Access Memory) and I/O (Input/Output). The microcomputer executes a program stored by the non-transitory entity storage medium to perform processing corresponding to the computer program and control the overall operation of the on-board device 2. In the on-board device 2, the non-transitory entity storage medium may share hardware with other computer resources. The probe data memory unit 8, the map data memory unit 9, and the application program memory unit 10 may be configured by one or more non-transitory entity storage media, each independently provided for the corresponding data, or by a common non-transitory entity storage medium. The storage device may be configured to include at least one of the probe data memory unit 8, the map data memory unit 9 and the application program memory unit 10. The storage device may be provided with circuitry for reading and rewriting data.

The server 3 includes a control unit 11, a data communication unit 12, a probe data memory unit 13, a map data memory unit 14, and an application program memory unit 15. The control unit 11 is composed of a microcomputer having a CPU, ROM, RAM, and I/O. The microcomputer executes a program stored by a non-transitory substantive storage medium to perform processing corresponding to the computer program and to control the overall operation of the server 3. In server 3, the non-transitory entity storage medium may share hardware with other computer resources; the probe data memory unit 13, the map data memory unit 14, and the application program memory unit 15 may be composed of independently provided non-transitory entity storage media for corresponding data, or they may be composed of a common non-transitory entity storage medium. The probe data memory unit 13, the map data memory unit 14 and the application program memory unit 15 may be configured by a single storage medium or by some storage areas in one or more storage mediums, and may be configured to include at least one of the probe data memory unit 13, the map data memory unit 14 and the application program memory unit 15. The storage device may include circuitry for reading and rewriting data.

When the peripheral information, the driving information and the position information are input, the control unit 6 of the on-board device 2 generates probe data based on the input information and stores the generated probe data in the probe data memory unit 8. The probe data includes the peripheral information, the driving information and the position information. More specifically, the probe data includes data indicating the position, color, characteristics, and relative position of traffic signals, signs, billboards, demarcation lines, stop lines at intersections, crosswalks, diamond-shaped marks in intersections, etc. on the road. The probe data includes data indicating road geometry, road features, road widths, etc. related to the road on which the vehicle is traveling.

The control unit 6 reads the probe data stored by the probe data memory unit 8 when, for example, a predetermined time has elapsed or when the vehicle has traveled a predetermined distance and causes the data communication unit 7 to transmit the read probe data to the server 3. Instead of this, the control unit 6 may read the probe data stored by the probe data memory unit 8 and cause the data communication unit 7 to transmit the read probe data to server 3 when the probe data transmission request sent by the server 3 is received by the data communication unit 7, in a case that the server 3 transmits the probe data transmission request periodically. The control unit 6 may cause the data communication unit 7 to transmit the probe data accumulated in the period from the previous ignition-on to the ignition-off to the server 3 at the timing of the ignition-on, or transmit the probe data accumulated in the period from the ignition-on to the ignition-off to the server 3 at the timing of the ignition-off. The control unit 6 may cause the data communication unit 7 to transmit the probe data to server 3 for each segment, which is a unit of predetermined area for map management, or for each predetermined area that is not related to the segment.

The map data memory unit 9 stores high-precision map data. The map data stored by the map data memory unit 9 includes three-dimensional map information, geographic feature information, and road attribute value information. The three-dimensional map information is information that includes point groups of feature points of road shapes and structures. The geographic feature information is information about the shape and position of traffic signals, signs, billboards, demarcation lines, stop lines at intersections, pedestrian crossings, diamond shape marks within intersections, etc. Road attribute value information is information about the lanes of a road, such as the number of lanes, whether there is a dedicated right-turn lane, etc. The map data stored by the map data memory unit 9 is sequentially updated as the map data stored by the map data memory unit 14 on the server 3 is downloaded from the server 3 to the on-board device 2.

The application programs stored by the application program memory unit 10 are various application programs that contribute to such as ADAS. The application programs include, for example, applications for Adaptive Cruise Control (ACC), Lane Change Assist (LCA), Lane Departure Warning (LDW), Lane Keeping Assist system (LKA), Forward Collision Warning (FCA), Traffic Sign Recognition (TSR; Traffic Sign Recognition), collision damage reduction braking system (AEBS; Advanced Emergency Braking System), etc. The Application stored by the application program memory unit 10 are updated as the application programs stored by application program memory unit 15 in the server 3 are downloaded from the server 3 to the on-board device 2.

The map data memory unit14 of the server 3 stores high-precision map data. The map data stored by the map data memory unit14 is larger than the map data stored by the map data memory unit9 of the on-board device 2 and includes information on a wider area. The control unit 11 receives the probe data transmitted by the on-board device 2 via the data communication unit 12 and stores the received probe data in the probe data memory unit 13. The control unit11 reads the probe data stored by the probe data memory unit13 and updates the map data stored by the map data memory unit 14 based on the read probe data. Therefore, the map data stored by the map data memory unit14 is the integrated map data generated based on the multiple probe data.

The application program memory unit 15 stores various application programs that contribute to, for example, ADAS, etc. The application programs stored by the application program memory unit 15 are updated as the functionality of the application programs is improved or bugs are fixed.

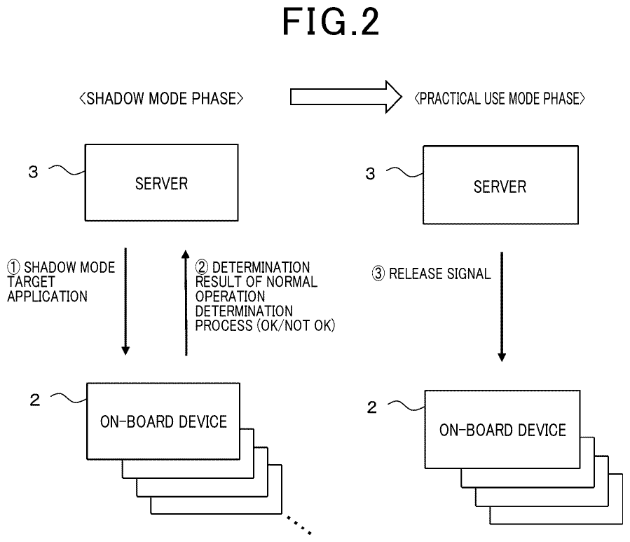

The application program downloaded from the server 3 to the on-board device 2 and operated by the on-board device 2 must be quality-verified. To verify the quality of the application program, the on-board device 2 and the server 3 have the following functions. As shown in FIG. 2, there are two operation modes in which the on-board device 2 executes application programs when traveling on public roads: a shadow mode and a practical use mode. The shadow mode is an operation mode in which operational signals of the application program are not reflected in real-world vehicle control when the application program is executed. For example, the on-board device 2, which executes the application program that implements the ACC in the shadow mode, executes the application program that implements the ACC, but the ACC operational signals output from the application program are not transmitted to the control mechanism related to the ACC. On the other hand, the practical use mode is an operation mode in which the operational signals of the application program are reflected in the real-world vehicle control when the application program is executed. For example, the on-board device 2, which executes an application program that implements the ACC in the practical use mode, executes the application program that implements the ACC and transmits the ACC operational signals output from the application program to the control mechanism related to the ACC. In this way, the operational signals of the application program are reflected in the real-world vehicle control.

The server 3 determines whether a pre-practical use operation verification is required for each of the plurality of application programs and registers additional information indicating that the application program that requires the pre-operational operation verification should be executed in the shadow mode (hereinafter referred to as “shadow mode information”). An application program that requires operation verification is an application program for which no guarantee has been obtained until the operational signals of the application program are reflected in real-world vehicle control. The server 3 manages the application programs for which shadow mode information has been registered as shadow mode target applications and transmits the shadow mode target applications to each of an unspecified number of the on-board devices 2. When each of the unspecified number of the on-board devices 2 receives the shadow mode target application transmitted by the server 3 and executes the received shadow mode target application, each of the on-board devices 2 verifies the operational signals of the application program with the driver's operation and the detection results of the autonomous system sensors mounted to the vehicle. Each of the on-board devices 2, based on the verification results, determines whether a normal operation of the application program is possible. When each of the on-board devices 2 determines that the normal operation of the application program is possible, the on-board device 2 transmits a determination result indicating that the normal operation of the application program is possible (hereinafter referred to as positive determination result) to the server 3, and when it determines that the normal operation of the application program is not possible, the on-board device 2 transmits a determination result indicating that the normal operation of the application program is not possible (hereinafter referred to as negative determination result) to the server 3.

The server 3 determines whether the application program can be used in the practical use mode by statistically analyzing the determination results (positive determination result or negative determination result) about the application program received from the on-board device 2. When the server 3 determines by the statistical analysis that the application program can be used in the practical use mode, the server 3 transmits a signal to each of the unspecified number of the on-board device 2 to release the shadow mode of the application program and causes the on-board device 2 to start executing the application program in the practical use mode. In this way, it is determined, for the application program for which additional information indicating that it is in the shadow mode is registered by each of the unspecified number of the on-board devices 2, whether the normal operation is possible in the shadow mode (normal operation determination process). The determination results are statistically analyzed by the server 3, and when the statistical analysis indicates that the application program can be used in the practical use mode, the shadow mode is released and the application program starts to be used in the practical use mode.

The on-board device 2 and the server 3 have the following functions as the configuration to realize the above process: the control unit 6 of the on-board device 2 includes a comparison unit 6a, a normal operation determination unit 6b, a determination result transmission unit 6c, and a vehicle control unit 6d. The comparison unit 6a compares the operational signals of the application program with the driver's operation and the detection results of the autonomous system sensors mounted to the vehicle. The normal operation determination unit 6b determines whether the normal operation of the application program is possible based on the comparison results of the comparison unit 6a.

Specifically, with respect to the application program that implements the ACC control, the comparison unit 6a compares the operational signals of the application program with the driver's operation and the detection results of the autonomous system sensors with respect to the numerical values of acceleration/deceleration and the vehicle speed, the timing of acceleration/deceleration, etc. The normal operation determination unit 6b may, for example, when the differences of the timing or operation amount of braking acceleration/deceleration are within predetermined ranges, determines the normal operation of the application program is possible. On the other hand, the normal operation determination unit 6b may, for example, when the differences in the timing or operation amount of braking acceleration/deceleration are out of within predetermined ranges, determines the normal operation of the application program is not possible. Thus, when the discrepancy between the driver's intended acceleration/deceleration, vehicle speed, and operation timing and the operation results of the application program that implements ACC is relatively small, the normal operation determination unit 6b determines the normal operation of the application program is possible. On the other hand, when the discrepancy between the driver's intended acceleration/deceleration, vehicle speed, and operation timing and the operation results of the application program that implements ACC is relatively large, the normal operation determination unit 6b determines the normal operation of the application program is not possible. The JJ6b may not make the determination when the speed limit has changed or when there is acceleration/deceleration associated with a change in a target vehicle speed set by the driver.

With respect to the application program that implements LCA, LDW, and LKA, the comparison unit 6a compares the operational signals of the application program regarding the timing of steering or the amount of the steering angle or, etc. with whether the driver's steering operation is performed, the timing of steering or the amount of the steering angle. When the driver's steering operation is performed and the differences of the timing or operation amount of steering are within predetermined ranges, the normal operation determination unit 6b determines the normal operation of the application program is possible. On the other hand, when the driver's steering operation is not performed or the differences of the timing or operation amount of steering are out of predetermined ranges, the normal operation determination unit 6b determines the normal operation of the application program is not possible. With respect to the application program that implements LCA, when the driver's steering operation is not performed after a turn signal operates, the normal operation determination unit 6b determines the normal operation of the application program is possible.

With respect to the application program that implements FCW, the comparison unit 6a compares the warning indication, warning sound output, etc. due to the application program with whether the driver's brake operation is performed and the timing of the brake operation. When the driver's brake operation is performed and the differences of the timing between the warning and brake operation are within predetermined ranges, the normal operation determination unit 6b determines the normal operation of the application program is possible. On the other hand, when the driver's brake operation is not performed or the differences of the timing between the warning and brake operation are out of predetermined ranges, the normal operation determination unit 6b determines the normal operation of the application program is not possible.

With respect to the application program that implements TSR, the comparison unit 6a compares the type of signs that the application program detected with the driver's operation or the vehicle status. When the application program detects a speed regulation sign, the driver's operation is performed, and the difference between the regulated speed and the vehicle speed is within a predetermined range, the normal operation determination unit 6b determines the normal operation of the application program is possible. On the other hand, when the application program detects a speed regulation sign, and the driver's operation is not performed or the difference between the regulated speed and the vehicle speed is out of a predetermined range, the normal operation determination unit 6b determines the normal operation of the application program is not possible. When the application program detects a Temporary-Stop sign, the driver's brake operation is performed, and the vehicle decelerates to a stop, the normal operation determination unit 6b determines the normal operation of the application program is possible. On the other hand, when the application program detects a Temporary-Stop sign, the driver's brake operation is not performed, or the driver's brake operation is performed but the vehicle does not stop, the normal operation determination unit 6b determines the normal operation of the application program is not possible. When the application program detects a No-Entry sign and the vehicle does not travel in the prohibited direction, the normal operation determination unit 6b determines the normal operation of the application program is possible. On the other hand, when the application program detects a No-Entry sign and the vehicle travels in the prohibited direction, the normal operation determination unit 6b determines the normal operation of the application program is not possible.

With respect to the application program that implements AEBS, the comparison unit 6a compares the collision mitigation operational signal from the application program with the driver's brake operation. When the application program outputs the collision mitigation operational signal and the driver's brake operation is performed, the normal operation determination unit 6b determines the normal operation of the application program is possible. On the other hand, when the application program outputs the collision mitigation operational signal and the driver's brake operation is not performed, the normal operation determination unit 6b determines the normal operation of the application program is not possible.

The determination result transmission unit 6c causes the data communication unit 7 to transmit the positive determination result or the negative determination result produced by the normal operation determination unit 6 to the server 3. The determination result transmission unit 6c may cause the data communication unit 7 to transmit, in addition to the positive determination result or the negative determination result, information regarding the determination target, information regarding the calculation results calculated in the determination process, information regarding the vehicle control and information regarding the peripheral environment. The determination result transmission unit 6c may select the positive determination result or the negative determination result to be sent to the server 3 based on the image recognition results. The determination result transmission unit 6c may determine whether to cause the data communication unit 7 to transmit the positive determination result or the negative determination result to the server 3 based on the accuracy of image recognition by comparing image recognition level with a threshold value. The determination result transmission unit 6c may cause the data communication unit 7 to transmit only the positive determination result or the negative determination result with respect to geographic objects whose recognition level is greater than or equal to a threshold value and may not cause the data communication unit 7 to transmit the positive determination result or the negative determination result with respect to geographic objects whose recognition level is less than the threshold value. Furthermore, the determination result transmission unit 6c may select the positive determination result or the negative determination result to be sent to the server 3 based on the detection results of the autonomous system sensors or the operation status of the on-board device unit, etc. Since the detection levels of the autonomous system sensors may decrease, the determination result transmission unit 6c may cause the data communication unit 7 to transmit the positive determination result or the negative determination result when the wiper is not in operation and the rainfall sensor does not detect rainfall and may not cause the data communication unit 7 to transmit the positive determination result or the negative determination result when the wiper is in operation or the rainfall sensor detects rainfall.

The information regarding the determination target includes the version of the map used, mesh (parcel) number, ID of the parcel line to be determined, distance from the parcel line endpoint, and other indicators that can identify the parcel line to be determined and which part of the parcel line was determined. The information regarding the calculation results includes the coordinates of the map data to be inspected in the vehicle's position coordinate system, the coordinates of the recognition points used for determination, the calculated distance, the x component of the distance, the mean and variance of the x component, the gradient of the data point sequence, the number of map data points and recognition points, etc. The information regarding the vehicle control includes the absolute coordinates of the vehicle position, steering angle, gas pedal state, brake state, and detection results of autonomous system sensors. Information on the surrounding environment includes the presence or absence of preceding vehicles, presence or absence of following vehicles, rainfall and snowfall conditions, etc.

The vehicle control unit 6d controls the vehicle based on the driver's actions and the detection results of the autonomous system sensors mounted to the vehicle.

The control unit 11 of server 3 includes a determination result reception unit 11a, a practical use determination unit 11b, and a practical use control unit 11c. These parts 11a-11c correspond to a part of the functions executed by the application program quality verification program. The control unit 11 realizes the functions of each part 11a-11c by executing a part of the application program quality verification program.

The determination result reception unit 11a receives the positive determination result or the negative determination result sent by the on-board device 2. The practical use determination unit 11b determines whether the application program can be practically used based on the positive determination result or the negative determination result sent by on-board device 2. The practical use determination unit 11b may perform a screening process and a statistical process by majority rule to determine whether the application program can be practically used.

The screening process is a process to exclude determination results that are expected to have a low correct response rate from determination results received from the on-board device 2, based on the information on the calculation results calculated in the determination process, the information on vehicle control, and the information on the peripheral environment. For example, the practical use determination unit 11b may exclude the determination result when it contains the information that the automatic driving control is not properly performed, when it contains the information on the status of each sensor that is malfunctioning, or when it contains the information on the existence of a preceding vehicle in the immediate distance in front, etc. The statistical processing by majority rule is a process that calculates which of the positive determination result and the negative determination result is the majority when there are multiple determination results that have completed the screening process, and adopts the determination result that is determined to be the majority.

When it is determined that the shadow mode target application can be practically used by the practical use determination unit 11b, the practical use control unit 11c transmits a release signal to the on-board device 2, releases the shadow mode, and starts the practical use mode of the application program in the on-board device 2. On the other hand, when the practical use control unit 11c determines that the shadow mode target application cannot be practically used by the practical use determination unit 11b, it does not release the shadow mode without transmitting the release signal to the on-board device 2 and does not permit the practical use mode of the application program in the on-board device 2.

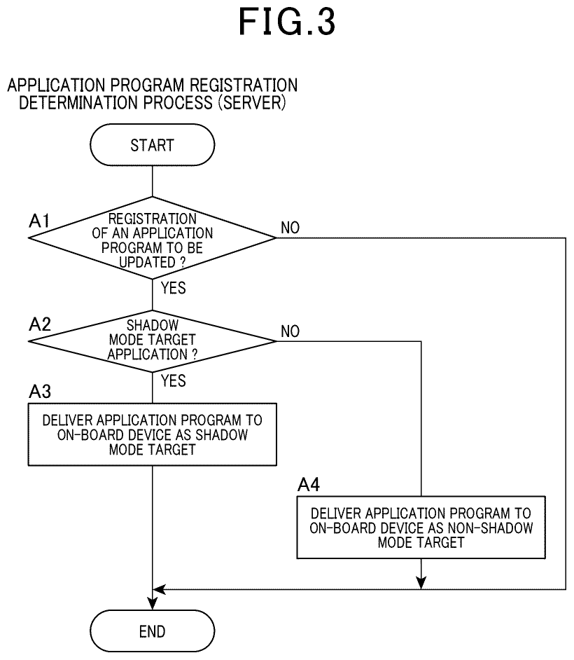

Next, the action of the above configuration will be explained with reference to FIGS. 3 to 6. The application program registration determination process performed by the server 3, the normal operation determination process performed by the on-board device 2, the practical use determination process performed by the server 3, and the shadow mode cancellation determination process performed by the on-board device 2 are explained in this order.

(1-1) The application Program Registration Determination Process Performed by the Server 3 (FIG. 3)

When the control unit 11 of the server 3 starts performing the application program registration determination process, the control unit 11 determines whether there is a registration of an application program to be updated (A1). For example, the application program to be updated is that functional improvement or bug modification was performed. When determining that there is no registration of an application program to be updated (A1: NO), the control unit 11 terminates this process. On the other hand, when determining that there is a registration of an application program to be updated (A1: YES), the control unit 11 determines whether the application program to be updated is the shadow mode target application (A2). Thus, control unit 11 determines whether the application program to be updated is the shadow mode target application that requires operation verification before practically used.

When the control unit 11 determines that the application program to be updated is the shadow mode target application (A2: YES), the control unit 11 delivers the application program to be updated to the on-board device 2 as an application program that is the shadow mode target (A3) and terminates this process. On the other hand, when the control unit 11 determines that the application program to be updated is not the shadow mode target application (A2: NO), the control unit 11 delivers the application program to be updated to on-board device 2 as an application program that is not the shadow mode target (A4) and terminates this process. The application program delivered from the server 3 to the on-board device 2 is stored by the application program memory unit 10.

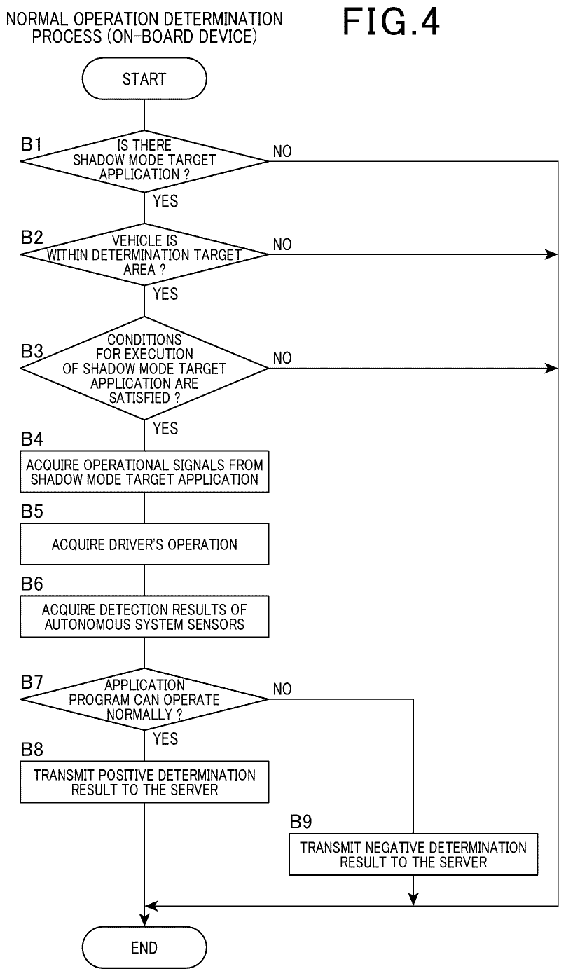

### (1-2) The Normal Operation Determination Process Performed by the On-Board Device 2 (FIG. 4)

When the control unit 6 of the on-board device 2 starts performing the normal operation determination process, it references data in the application program memory unit 10 and determines whether there is the shadow mode target application (B1). When determining that there is no shadow mode target application (B1: NO), the control unit 6 terminates this process. When there is the shadow mode target application stored by the application program memory unit 10 (B1: YES) the control unit 6 compares the position of the vehicle with the map data and determines whether the position of the vehicle is within the determination target area (B2). When determining that the position of the vehicle is out of the determination target area (B2: NO), the control unit 6 terminates this process.

When determining that the position of the vehicle is within the determination target area (B2: YES), the control unit 6 determines whether the conditions for execution of the shadow mode target application are satisfied (B3). The conditions for execution of the shadow mode target application include conditions about the position of the vehicle, acceleration/deceleration, vehicle speed, distance from the vehicle to the preceding vehicle, peripheral environment of the vehicle, etc. When determining that the conditions for execution of the shadow mode target application are not satisfied (B3: NO), the control unit 6 terminates this process.

When determining that the conditions for executing the shadow mode target application are satisfied (B3: YES), the control unit 6 executes the shadow mode target application and acquires the operational signals from the shadow mode target application (B4), acquires the driver's operation (B5), and acquires the detection results of the autonomous system sensors (B6). The control unit 6 compares the operational signals of the application program with the driver's operations and the detection results of the autonomous system sensors to determine whether the application program can operate normally (B7). When the application program implements ACC, for example, when the discrepancy between the driver's intended acceleration/deceleration, vehicle speed, and operation timing and the operation results of the application program that implements ACC is relatively small, the control unit 6 determines the normal operation of the application program is possible. On the other hand, when the discrepancy is relatively large, the control unit 6 determines the normal operation of the application program is not possible. The control unit 6 performs processes in a same manner for the application programs implementing LCA, LDW, LKA, FCW, TSR, and AEBS.

When determining the normal operation of the application program is possible (B7: YES), the control unit 6 causes the data communication unit 7 to transmit the positive determination result to the server 3 (B8) and terminates this process. On the other hand, determining the normal operation of the application program is not possible (B7: NO), the control unit 6 causes the data communication unit 7 to transmit the negative determination result to the server 3 (B9) and terminates this process. When the conditions for execution of the plurality of shadow mode target applications are satisfied, the control unit 6 may determine whether the normal operation is possible for each of the multiple application programs by performing the above processes in parallel.

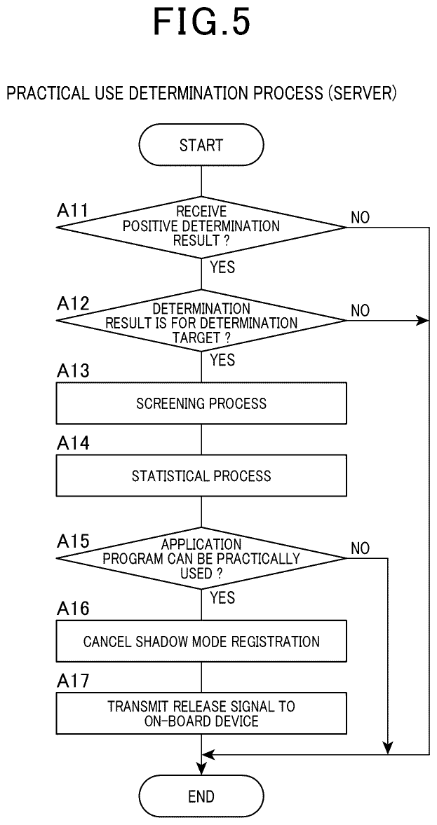

### (1-3) The Practical Use Determination Process Performed by Server 3 (FIG. 5)

When the control unit 11 of the server 3 starts the practical use determination process, the control unit determines whether the server 3 receives the determination result indicating whether the normal operation of the application program is possible from the on-board device 2 (A11, an example of the determination result receiving procedure). When determining that the server 3 does not receive the determination result from on-board device 2 (All: NO), the control unit 11 terminates this process. When determining that the server 3 receives the determination result from on-board device 2 (A11: YES), the control unit 11 determines whether the received determination result is for an application program that is a determination target (A12). When determining the received determination result is not for an application program that is a determination target (A12: NO), the control unit 11 terminates this process.

When determining the received determination result is for an application program that is determination target (A12: YES), the control unit 11 performs the screening process (A13), performs the statistical process (A14), and determines whether the application program can be practically used (A15, an example of practical use determination process). For example, the control unit 11 determines whether the application program can be practically used by monitoring the ratio of the positive determination results or the number of the positive determination results. When determining the application program cannot be practically used, the control unit 11 terminates this process.

The control unit 11 determines the application program can be practically used when the ratio of the positive determination results is greater than or equal to a predetermined value or the number of the positive determination results is greater than or equal to a predetermined value (A15: YES). In this case, the control unit 11 cancels the shadow mode registration (A16, an example of practical use control procedure), causes the data communication unit 12 to transmit the release signal to the on-board device 2 (A17), and terminates this process.

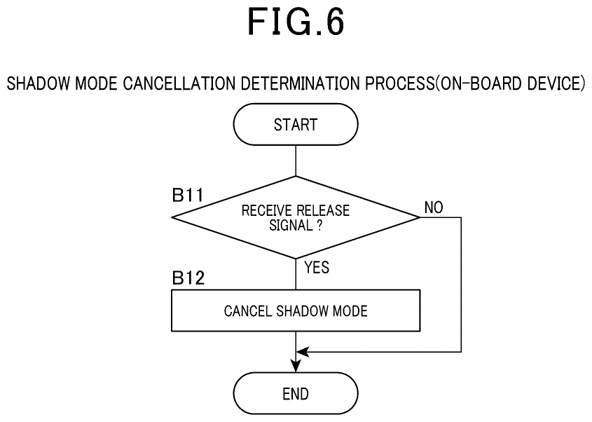

### (1-4) The Shadow Mode Cancellation Determination Process Performed by On-Board Device (FIG. 6)

When the control unit 6 of on-board device 2 starts shadow mode cancellation determination process, the control unit 6 determines whether the control unit 6 receives the release signal from server the 3 (B11).

When determining that the control unit 6 does not receive the release signal from the server 3 (B11: NO), the control unit 6 terminates this process. When determining that the control unit 6 receives the release signal from the server 3 (B11: YES), the control unit 6 cancels the shadow mode (B12) and terminates this process.

As explained above, when the on-board device 2 receives the shadow mode target application transmitted by the server 3, the on-board device 2 compares the operational signals of the application program with the driver's operation and the detection results of the autonomous system sensors mounted to the vehicle, determines whether the normal operation of the application program is possible based on the comparison results, and transmits the determination result indicating whether the normal operation of the application program is possible to the server 3. When the server 3 receives the determination result indicating whether the normal operation of the application program is possible transmitted by the on-board device 2, the server 3 determines whether the application program can be practically used based on the received determination result, and when determining that the application program can be practically used, the server 3 allows the application program to be practically used. According to the first embodiment, it is possible to determine whether the normal operation of the application program is possible and whether the application program can be practically used without constructing a simulation environment or conducting a test run with a test vehicle. Thus, according to the first embodiment, it is possible to reduce the time and cost required to verify the quality of application programs, properly verify the quality of application programs, and properly provide application programs whose quality is assured.

Additionally, according to the first embodiment, the application program registered in shadow mode is a target of comparison, when it is determined to be practically used, the shadow mode is cancelled, and the application program starts to be practically used. On the other hand, when it is not determined to be practically used, the shadow mode is maintained, and the application program does not start to be practically used. It is possible to determine whether to start the practical use of the application program before starting to be practically used.

### Second Embodiment

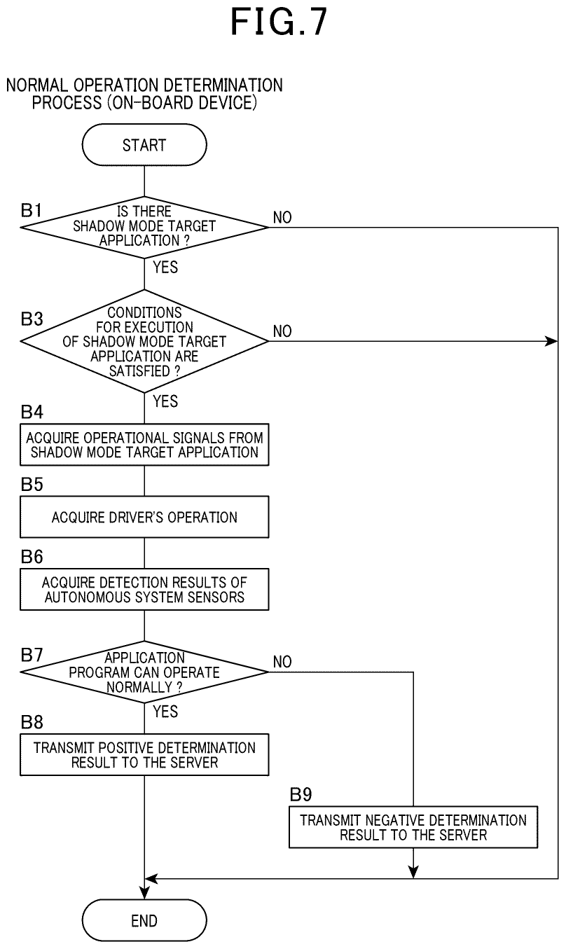

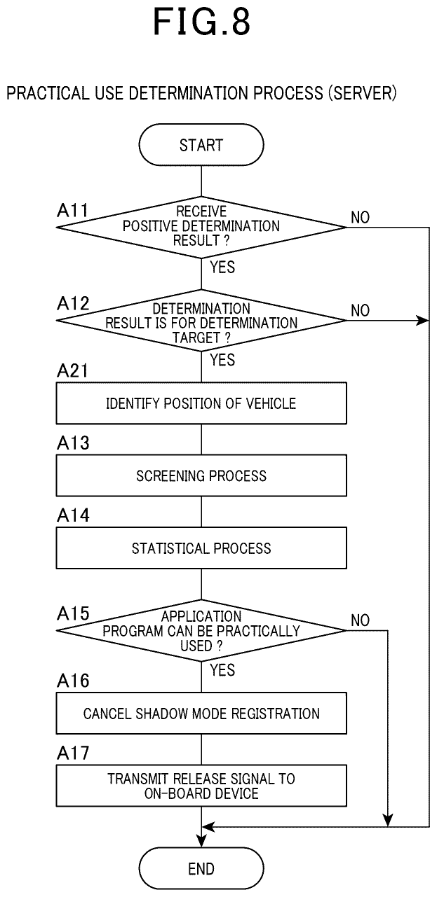

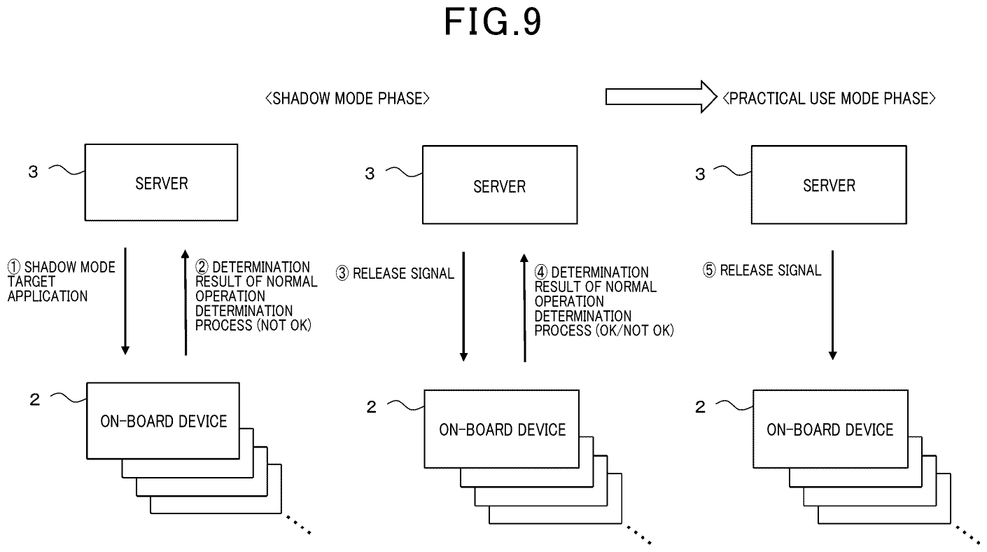

Next, a second embodiment is explained with reference to FIGS. 7 to 8. In the first embodiment, the on-board device 2 holds the map data, but in the second embodiment, the on-board device 2 does not hold the map data.

### (2-1) The Normal Operation Determination Process Performed by the On-Board Device 2 (FIG. 7)

When the control unit 6 of the on-board device2 determines that there is a shadow mode target application (B1: YES), the control unit 6 determines whether the condition for execution of the shadow mode target application is satisfied (B3), without performing step B2 described in the first embodiment. Steps B4 to B9 described in the first embodiment are performed.

### (2-2) The Practical Use Determination Process Performed by the Server 3 (FIG. 8)

When the control unit 11 of server 3 determines that the control unit 11 receives the determination result indicating whether the application program can operate normally from the on-board device 2 (A11: YES) and when the control unit 11 determines that the determination result is for the application program that is a determination target (A12: YES), the control unit 11 identifies the position of the vehicle that executing the shadow mode target application on the map data based on the position of the vehicle received from the on-board device 2 (A21). Then the control unit 11 performs steps A13 to A17 described in the first embodiment.

As explained above, according to the second embodiment, even in a configuration where the on-board device 2 does not hold map data, the server 3 identifies the position on the map data where the on-board device 2 performed the shadow mode target application, thereby achieving the same effect as the first embodiment.

### Third Embodiment

Next, a third embodiment is explained with reference to FIG. 9. In the first and second embodiments, the on-board device 2 receives the shadow mode target application sent by the server 3 in the normal operation determination process of the application program, and when it determines that the application program can operate normally, it transmits the positive determination result to server 3. In the third embodiment, the on-board device 2 transmits only the negative determination result to server 3.

As shown in FIG. 9, when receiving the shadow mode target application transmitted by the server 3, the on-board device 2 compares the operational signal of the application program with the driver's operation and the detection results of the autonomous system sensors and determines whether the application program can operate normally based on the comparison. When determining that the normal operation of the application program is possible, the on-board device2 does not transmit the positive determination result to the server 3. When determining that the normal operation of the application program is not possible, the on-board device2 transmits the negative determination result to the server 3.

The server 3 receives the negative determination results sent by the unspecified number of on-board device 2 and accumulates the received negative determination results. The server 3 determines whether the negative determination result frequency is greater than or equal to a threshold value. When determining that the frequency of negative determination results is greater than or equal to the threshold value, the server 3 transmits a request signal to the unspecified number of on-board devices 2.

After receiving the request signal sent by the server 3, when determining the normal operation of the application program is possible, the on-board device 2 transmits the positive determination result to the server 3, and when determining the normal operation of the application program is not possible, the on-board device 2 transmits the negative determination result to the server 3. Thereafter, as in the first embodiment, when the server 3 receives the positive determination result or the negative determination result sent by the on-board device 2, the server 3 statistically analyzes the received determination results to determine whether the application program can be practically used.

As explained above, according to the third embodiment, the server 3 transmits a request signal to the on-board device 2 when the frequency of the negative determination result transmitted by the on-board device 2 is greater than or equal to the threshold value. The on-board device 2, after receiving the request signal transmitted by the server 3, transmits the determination result indicating whether the application program can operate normally to the server 3. According to this system, at first, only the negative determination result is sent from the on-board device 2 to the server 3, and both positive determination result and negative determination result are sent from the on-board device 2 to the server 3 after the frequency of the negative determination result exceeds the threshold value, thereby suppressing the increase in the volume of data communication from the on-board device 2 to the server 3. This allows detailed investigations to be performed on programs that have been determined to be unable to operate normally.

### Fourth Embodiment

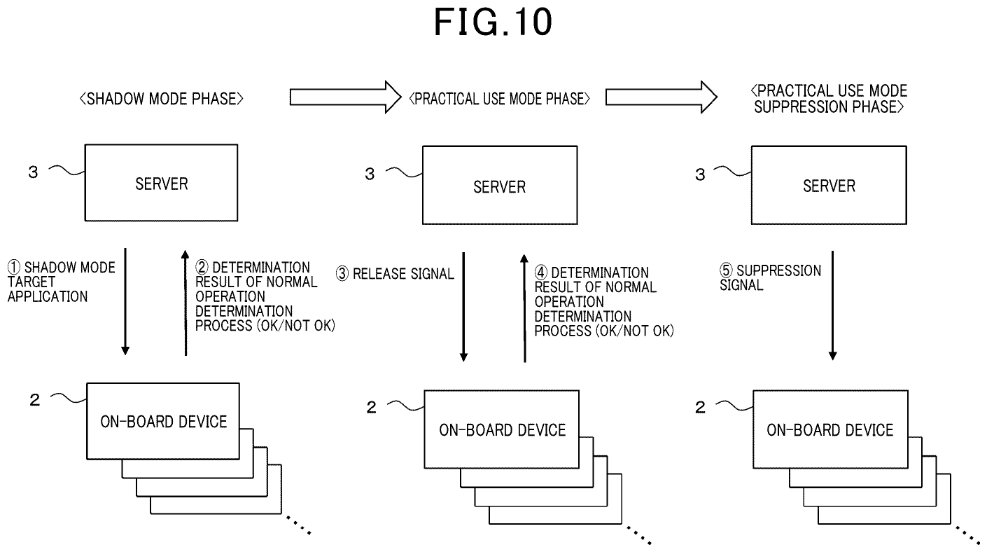

Next, a fourth embodiment is explained with reference to FIG. 10. The first to third embodiments are configured in such a way that the on- board device 2 determines whether the application program can operate normally only for an application program in the shadow mode. The fourth embodiment is a configuration in which the on-board device 2 determines whether the application program can operate normally even in the practical use mode.

As shown in FIG. 10, even after the start of practical use in which the shadow mode is released by receiving the release signal sent by the server 3, the on-board device 2 compares the operational signals of the application program with the driver's operation and the detection results of the autonomous system sensors. The on-board device 2 transmits the determination results to the server 3.

When receiving the determination results, the server 3 determines whether the application program can be practically used based on the statistical analysis. When the server determines the application program can be practically used, the practical use mode is continued in the on-board device 2. When the server determines the application program cannot be practically used, the server transmits a suppression signal to the on-board device 2 and suppresses the practical use mode to be continued in the on-board device 2. In this way, the application program whose shadow mode is released and operation in the practical use mode is started by the on-board device 2, is determined whether the normal operation is possible, and the positive determination result or the negative determination result by the on-board device 2 is statistically analyzed by the server 3.

As explained above, according to the fourth embodiment, it is determined, after the application program starts to be practically used whether it can be practically used.

### Another Embodiments

Although this disclosure has been described in accordance with examples, it is understood that it is not limited to said examples or structures. The present disclosure also encompasses various variations and transformations within the scope of equality. In addition, various combinations and forms, as well as other combinations and forms including only one element, thereof, also fall within the scope of the present disclosure and the scope of ideas.

The control unit and the methods described in this disclosure may be realized by a dedicated computer provided by configuring a processor and memory programmed to perform one or more functions embodied by a computer program. Alternatively, the control unit and the methods described in this disclosure may be realized by a dedicated computer provided by configuring the processor with one or more dedicated hardware logic circuits. The control unit and the methods described in this disclosure may be realized by one or more dedicated computers provided by a combination of a processor and memory programmed to perform one or more functions and a processor configured by one or more dedicated hardware logic circuits. The computer program may also be stored by a computer-readable non-transitory recording medium as instructions to be executed by a computer.

In addition to the inventions described in the claims, this disclosure includes the following disclosures.
[1] An application program quality verification system (1) that verifies the quality of the application program delivered to a on-board device from the application program distribution device, the application program quality verification system including:
   a comparison unit (6a ) that compares operational signals of the application program with comparison targets;
   a normal operation determination unit (6b ) that determines whether the application program can operate normally based on the comparison results of the comparison unit;
   a practical use determination unit (11b ) that determines whether the application program can be practically used based on the determination results of the normal operation determination unit; and
   a practical use control unit (11c ) that allows the application program to be practically used when the practical use determination unit determines that the application program can be practically used.
[2] The application program quality verification system according to [1], wherein
   the comparison unit compares the operational signals of the application program for which shadow mode information is registered with at least one of a vehicle driver's operation and detection results of autonomous system sensors mounted to the vehicle, and
   the practical use control unit cancels the shadow mode and allows the application program to be practically used when the practical use determination unit determines that the application program for which the shadow mode information is registered can be practically used.
[3] The application program quality verification system according to [2], wherein
   the practical use control unit inhibits the application program from being practically used when the practical use determination unit determines that the application program for which the shadow mode information is registered cannot be practically used.
[4] The application program quality verification system according to [1], wherein
   the comparison unit compares the operational signals of the application program that is already started to be practically used with at least one of a vehicle driver's operation and detection results of autonomous system sensors mounted to the vehicle, and
   the practical use control unit allows the application program to be continuously practically used when the practical use determination unit determines that the application program that is already started to be practically used can be practically used.
[5] The application program quality verification system according to [4], wherein
   the practical use control unit inhibits the application program from being practically used continuously when the practical use determination unit determines that the application program that is already started to be practically used cannot be practically used.
[6] The application program quality verification system according to [1] to [5], wherein
   the on-board device includes the comparison unit, the normal operation determination unit, and a determination result transmission unit (6c ) that transmits the determination results of the normal operation determination unit to an application program distribution device,
   the application program distribution device includes a determination result reception unit (11a ) that receives the determination results of the normal operation determination unit, the practical use determination unit and the practical use control unit.
[7] The application program quality verification system according to [6], wherein
   the determination result transmission unit selects some or all the determination results of the normal operation determination unit based on an image recognition result, detection results of autonomous system sensors mounted to the vehicle, or the operation status of the on-board device and transmits the selected determination results of the normal operation determination unit to the application program distribution device.
[8] The application program quality verification system according to [6], wherein
   the determination result transmission unit, until a predetermined condition is satisfied, transmits only the determination results of the normal operation determination unit that indicates the application program cannot operate normally and does not transmit the determination results of the normal operation determination unit that indicates the application program can operate normally, and
   the determination result transmission unit, after the predetermined condition is satisfied, transmits one of the determination results of the normal operation determination unit that indicates the application program can operate normally and that indicates the application program cannot operate normally.
[9] The application program quality verification system according to [8], wherein
   the predetermined condition is that the application program distribution device determines that the frequency of the determination results that indicates the application program cannot operate normally is greater than or equal to a threshold value, the determination results being produced by the normal operation determination unit.
[10] An application program distribution device that distributes application programs to on-board devices, the application program distribution device including:
   a determination result reception unit (11a ), that receives determination result of whether the application program can operate normally based on the comparison results of operational signals of the application program with comparison targets;
   a practical use determination unit (11b ) that determines whether the application program can be practically used based on the determination result received by the determination result reception unit; and
   a practical use control unit (11c ) that allows the application program to be practically used when the practical use determination unit determines that the application program can be practically used.
[11] A program causing a control unit (11) of the application program distribution device (3) to perform:
   receiving determination result of whether the application program can operate normally based on the comparison results of operational signals of the application program with comparison targets;
   determining whether the application program can be practically used based on the received determination result; and
   allowing the application program to be practically used when it is determines that the application program can be practically used.

What is claimed is:

1. An application program quality verification system that verifies the quality of the application program delivered to a on-board device from the application program distribution device, the application program quality verification system comprising:
a comparison unit that compares operational signals of the application program with comparison targets;
a normal operation determination unit that determines whether the application program can operate normally based on the comparison results of the comparison unit;
a practical use determination unit that determines whether the application program can be practically used based on the determination results of the normal operation determination unit; and
a practical use control unit that allows the application program to be practically used when the practical use determination unit determines that the application program can be practically used.

2. The application program quality verification system according to claim 1, wherein
the comparison unit compares the operational signals of the application program for which shadow mode information is registered with at least one of a vehicle driver's operation and detection results of autonomous system sensors mounted to the vehicle, and
the practical use control unit cancels the shadow mode and allows the application program to be practically used when the practical use determination unit determines that the application program for which the shadow mode information is registered can be practically used.

3. The application program quality verification system according to claim 2, wherein
the practical use control unit inhibits the application program from being practically used when the practical use determination unit determines that the application program for which the shadow mode information is registered cannot be practically used.

4. The application program quality verification system according to claim 1, wherein
the comparison unit compares the operational signals of the application program that is already started to be practically used with at least one of a vehicle driver's operation and detection results of autonomous system sensors mounted to the vehicle, and
the practical use control unit allows the application program to be continuously practically used when the practical use determination unit determines that the application program that is already started to be practically used can be practically used.

5. The application program quality verification system according to claim 4, wherein
the practical use control unit inhibits the application program from being practically used continuously when the practical use determination unit determines that the application program that is already started to be practically used cannot be practically used.

6. The application program quality verification system according to claim 1, wherein
the on-board device comprises the comparison unit, the normal operation determination unit, and a determination result transmission unit that transmits the determination results of the normal operation determination unit to an application program distribution device,
the application program distribution device comprises a determination result reception unit that receives the determination results of the normal operation determination unit, the practical use determination unit and the practical use control unit.

7. The application program quality verification system according to claim 6, wherein
the determination result transmission unit selects some or all the determination results of the normal operation determination unit based on an image recognition result, detection results of autonomous system sensors mounted to the vehicle, or the operation status of the on-board device and transmits the selected determination results of the normal operation determination unit to the application program distribution device.

8. The application program quality verification system according to claim 6, wherein
the determination result transmission unit, until a predetermined condition is satisfied, transmits only the determination results of the normal operation determination unit that indicates the application program cannot operate normally and does not transmit the determination results of the normal operation determination unit that indicates the application program can operate normally, and
the determination result transmission unit, after the predetermined condition is satisfied, transmits one of the determination results of the normal operation determination unit that indicates the application program can operate normally and that indicates the application program cannot operate normally.

9. The application program quality verification system according to claim 8, wherein
the predetermined condition is that the application program distribution device determines that the frequency of the determination results that indicates the application program cannot operate normally is greater than or equal to a threshold value, the determination results being produced by the normal operation determination unit.

10. An application program distribution device that distributes application programs to on-board devices, the application program distribution device comprising:
a determination result reception unit, that receives determination result of whether the application program can operate normally based on the comparison results of operational signals of the application program with comparison targets;
a practical use determination unit that determines whether the application program can be practically used based on the determination result received by the determination result reception unit; and
a practical use control unit that allows the application program to be practically used when the practical use determination unit determines that the application program can be practically used.

11. A non-transitory computer-readable storage medium storing a program, the program causing a control unit of the application program distribution device to perform:
receiving determination result of whether the application program can operate normally based on the comparison results of operational signals of the application program with comparison targets;
determining whether the application program can be practically used based on the received determination result; and
allowing the application program to be practically used when it is determines that the application program can be practically used.
